(19) United States
(12) Patent Application Publication
(10) Pub. No.: US 2003/0086333 A1
(43) Pub. Date: May 8, 2003

(54) Electrohydrodynamic mixing on microfabricated devices

(76) Inventors: Constantinos Tsouris, Oak Ridge, TN (US); David W. DePaoli, Knoxville, TN (US); Christopher T. Culbertson, Oak Ridge, TN (US); Stephen C. Jacobson, Knoxville, TN (US); J. Michael Ramsey, Knoxville, TN (US)

Correspondence Address: UT-Battelle, LLC, P. O. Box 2008, Oak Ridge, TN, 37831-6498, US

(21) Appl. No.: 10/007,356

(22) Filed: Nov. 5, 2001

(51) Int. Cl. B01F 5/06

(52) U.S. Cl. 366/173.1; 366/174.1; 366/336; 422/224

(57) ABSTRACT

A device for electrohydrodynamically (EHD) mixing fluids includes a mixing channel, the mixing channel having at least one supply channel fluidicly connected thereto for transport of fluid into the mixing channel. At least two electrodes are provided, at least one of the electrodes for charging at least a portion of the fluid in the mixing channel. The electrodes impose an electric field in the mixing channel to induce EHD mixing of the fluid in the mixing channel. A method for EHD mixing of fluids applies an electric field to a mixing channel to induce EHD mixing.

### STATEMENT REGARDING FEDERALLY SPONSORED RESEARCH OR DEVELOPMENT

The United States Government has rights in this invention pursuant to Contract No. DE-AC05-000R22725 between the United States Department of Energy and UT-Battelle, LLC.

### FIELD OF THE INVENTION

This invention relates to a method and apparatus for electrohydrodynamic mixing of fluids.

### BACKGROUND OF THE INVENTION

Interest in microfabricated instrumentation for chemical processing, sensing and analysis has grown considerably over recent years primarily because miniature instruments use low volumes and may permit low cost production. For liquid phase analysis, microfabricated fluidic devices (microchips) constructed on planar substrates can be used for manipulating small sample volumes, rapidly processing materials, and integrating sample pretreatment and separation strategies. These miniature devices can provide a platform for applications such as chemical reactors, sensors and analyzers. One method for transporting and mixing fluid samples and reagents on these microfluidic devices is electrokinetic transport.

The ability to manipulate reagents and reaction products on-chip can be used to replace various “wet-chemical” bench procedures. Replacing a laboratory full of conventional chemical analysis instrumentation with a microchannel device can include the advantages of reducing reagent volumes, automating material manipulation with no moving parts, reducing capital costs, increasing parallel processing, increasing processing speed and remote operation and monitoring.

By implementing multiple processes in a single serially integrated device, small fluid quantities can be manipulated from process to process efficiently and automatically under computer control. The serial integration of multiple analysis steps can be combined with parallel expansion of processing capacity by replicating microfabricated structures, such as parallel separation channels, on the same device.

Electrokinetic transport includes electroosmosis for fluid pumping through microchannels and electrophoresis for the separation of the components of a liquid mixture. Electrokinetic transport, however, has limitations dictated by the physical properties of the fluids. For instance, electrokinetic transport cannot be used efficiently for nonpolar solvents, such as most organic solvents. Also, fluid mixing is generally limited to miscible aqueous systems and in most cases, depends on relatively slow diffusion mechanisms.

Electrohydrodynamics concerns fluid motion due to externally applied electric fields. When a liquid contacts a biased charging electrode, electrochemical charge exchange reactions occur whereby a portion of the liquid becomes electrically charged by interaction of the liquid with the charging electrode. Charged particles created at the electrode are directed by an electric field that is set up by a potential difference that is applied between the charging electrode and a counter electrode. The counter electrode is held at a different potential than the charging electrode potential.

Electrohydrodynamics has been used for pumping fluids and is disclosed in U.S. Pat. No. 5,632,876 to Zanzucchi et al. entitled “Apparatus and methods for controlling fluid flow in microchannels.” By combining electroosmotic and electrohydrodynamic pumps in a microchannel device, both polar and non-polar fluids are moved along a single flow channel. The electrohydrodynamic pumps disclosed are formed from pairs of wire electrodes inserted into openings in the flow channel. The wires are connected to a source of a pulsed DC power. By reversing the voltages on alternate pairs of pumps, fluid flow can be reversed, thereby acting as an electronic fluid gate or valve.

### SUMMARY OF THE INVENTION

The invention employs electrohydrodynamic (EHD) phenomena to mix fluids. For fluids of relatively low conductivity and moderate to high dielectric constant, such as most organic fluids, EHD transport is generally a more efficient process than electrokinetic transport.

In a first embodiment, a microchannel mixing device for electrohydrodynamic mixing of fluids includes a mixing channel. The mixing channel has at least one inlet for receiving at least one fluid. At least one supply channel is fluidicly connected to the mixing channel inlet for transport of at least one fluid into the mixing channel inlet. At least two electrodes are provided for imposing an electric field in the mixing channel and at least one of the electrodes is adapted for charging at least a portion of the fluid.

In a second embodiment, at least one of the electrodes in the device in the first embodiment can be a fluid isolated electrode, the fluid isolated electrode disposed in close proximity to the mixing channel and not in contact with the fluid. The fluid isolated electrode can be disposed at a location along the length of the mixing channel.

The mixing device can include a cover plate attached to a substrate support layer. The microchannels can be formed in the cover plate and the cover plate can be gas permeable. The microchannel widths and depths are typically in the range of 10 to 100 μm, but smaller or larger dimensions can be used.

The mixing device can include at least one power supply for applying a constant or varying voltage to any of the electrodes to induce EHD mixing. Separate power supply channels can permit application of a first polarity of voltage to a first electrode and the other polarity to the second electrode.

### BRIEF DESCRIPTION OF THE DRAWINGS

A fuller understanding of the present invention and the features and benefits thereof will be accomplished upon review of the following detailed description together with the accompanying drawings, in which:

FIG. 1 illustrates an electrohydrodynamic (EHD) microchannel mixing device, according to an embodiment of the invention.

FIG. 2 illustrates a microchannel mixing device having electrodes disposed to generate an electric field oriented substantially transverse to the direction of fluid flow, according to an embodiment of the invention.

FIG. 3 illustrates a microchannel mixing device having a fluid isolated electrode, according to another embodiment of the invention.

FIG. 4 illustrates a microchannel mixing device with an alternative electrode design for EHD mixing, according to another embodiment of the invention.

FIG. 5(a) illustrates a fluorescence image showing the mixing of two liquids resulting from diffusive transport alone with no applied voltage.

FIG. 5(b) illustrates a fluorescence image showing moderate mixing of two liquids resulting from application of a first applied voltage.

FIG. 5(c) illustrates a fluorescence image showing substantially uniform mixing of two liquids resulting from application of a second applied voltage, the second applied voltage greater in magnitude than the first applied voltage.

FIG. 6 illustrates the fluorescence intensity of cross sections of the respective images in FIGS. 5(a), (b) and (c) taken transverse to the fluid flow at a point 80 μm downstream from the mixing point of the fluids.

### DETAILED DESCRIPTION OF THE PREFERRED EMOBIDIMENTS

The invention mixes liquids by electrohydrodynamic (EHD) phenomena. The invention can be used to mix both miscible, partially miscible and immiscible fluids. Although generally described for the mixing of two fluids, one or more fluids can be mixed using the invention.

Although electrokinetic transport alone can be used to mix most ionic and strongly polar miscible aqueous liquids, electrokinetic transport cannot be used to effectively mix nonpolar liquids, such as most organic solvents and non-miscible liquids. An EHD mixing device is preferably a microfabricated fluidic device (microchip) formed on a glass, silicon, silica, ceramic or polymeric substrate. Using the invention, fluids can be rapidly mixed over distances of as little as tens of microns and result in thorough mixing occurring approximately several hundreds times faster, and in correspondingly shorter distances, as compared to diffusive transport alone.

A device for mixing fluids includes a mixing channel, the mixing channel having at least one inlet for receiving fluids and a region for mixing fluids. At least one fluid supply channel is provided for transport of a fluid into the mixing channel. At least one electrode is provided for charging at least a portion of either of the fluids. The electrodes also provide an electric field along or across the mixing channel.

The invention can implement multiple processes in a single integrated device by providing a plurality of fluidly connected discrete mixing devices, preferably on a microchip. Using this arrangement, small fluid quantities can be manipulated from process to process efficiently and automatically, preferably under computer control.

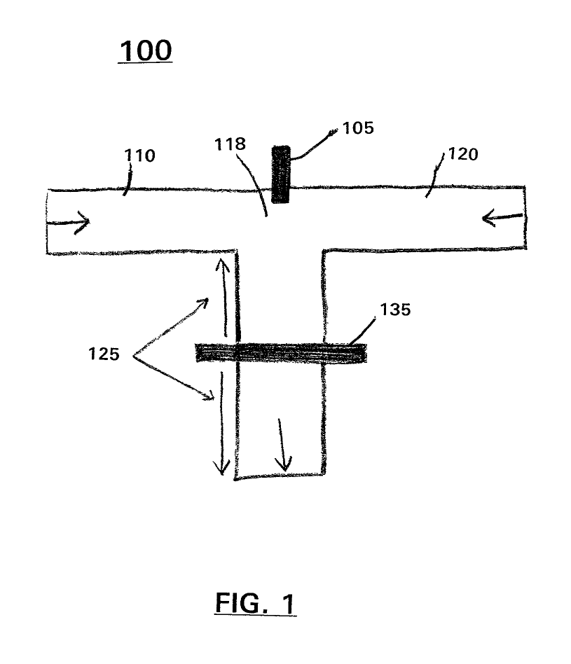

A variety of channel and electrode designs can be used with the invention. A schematic of a microchannel mixing device 100 includes a T-intersection channel design, comprising a first fluid supply channel 110, a second fluid supply channel 120 and a mixing channel 125 as shown in FIG. 1. Supply channels 110 and 120 can also be connected to fluid reservoirs, to supply a first and second fluid for mixing (not shown). An output reservoir (not shown) can provide access to the mixed fluids at a distal end of mixing channel 125. The first and second fluids can be substantially pure materials, or mixtures of materials.

A first electrode 105 and second electrode 135 can be provided. The first electrode 105 can be placed near, or at, the intersection 118 of supply channels 110 and 120 for charging at least a portion of either of the fluids. The application of a potential difference between the first and second electrodes 105 and 135 generates an electric field in the mixing channel 125 between electrodes 105 and 135. Electrode 135 can be disposed some distance from the intersection 118 along the length of mixing channel 125. For example, electrode 135 can be positioned 100 μm downstream from intersection 118. The closer electrodes 105 and 135 are spaced apart, the lower the applied potential needed to induce mixing. In addition, electrode 105 preferably has a small cross-sectional area at its distal end for increased current density and more efficient charge injection.

The dynamics of mixing device 100 during operation can be summarized as follows. The first fluid flowing in microchannel 110 and second fluid flowing in microchannel 120 both proceed toward electrode 105 as shown by the arrows in FIG. 1 under influence of a propelling force, such as an applied pressure differential imposed across each respective supply channel. Although two supply channels 110 and 120 are shown, it is possible to provide a plurality of fluids to the mixing microchannel 125 using a single supply channel.

In the case where fluid reservoirs are held at ambient pressure, a sub-ambient pressure source (not shown) operatively connected to an outlet of the mixing channel 125 can draw fluids held at ambient pressure towards the sub-ambient pressure source. Alternatively, fluid supply reservoirs can be pressurized at a pressure above ambient pressure to transport the respective fluids into the mixing channel 125.

The mixing ratio for fluids in microchannel mixing device 100 depends on the forces applied to the ends of the fluid supply channel(s) and/or mixing channel 125 as well as the geometry of the respective channels. Channel geometries need not be equivalent to one another.

Charge exchange reactions occur at electrode 105 for one or a portion of each respective fluid. Under the influence of an appropriate electric field resulting from applying a sufficient potential difference between electrodes 105 and 135, the first and second fluids experience substantial mixing as they flow along the length of the mixing channel 125.

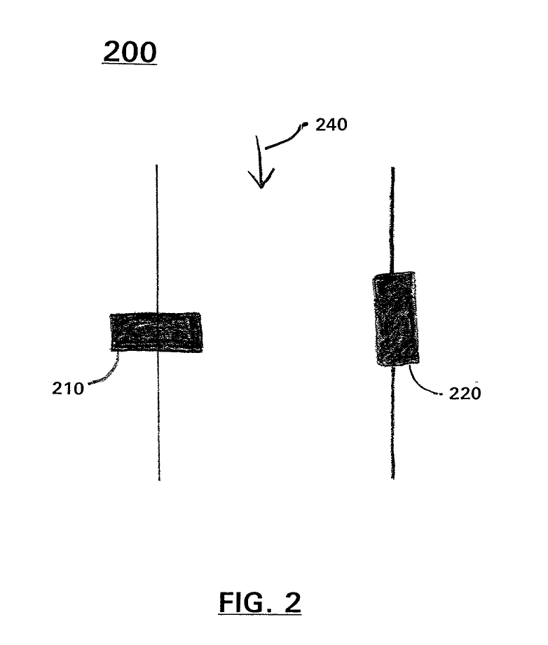

FIG. 2 shows a microchannel mixing device 200 having electrodes 210 and 220 which can provide an electric field oriented substantially transverse to the direction of fluid flow 240. This can be compared to the embodiment shown in FIG. 1 which results in an electric field which is oriented substantially parallel or anti-parallel to the direction of fluid flow.

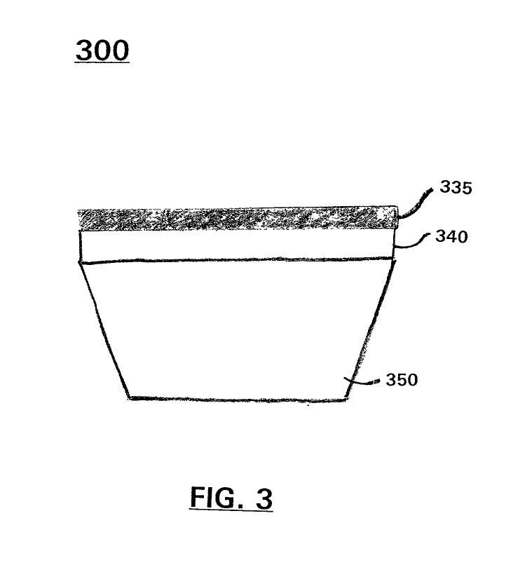

Although the microchannel mixing devices 100 and 200 disposes both electrodes in solution, only one electrode is required to be in solution for operation of mixing device 100. For example, FIG. 3 shows a mixing channel cross section 300 having a fluid isolated (dry) electrode 335 disposed on a cover plate 340. The placement of dry electrode 335 shown in FIG. 3 is an alternative to placing the counter electrode in solution, such as electrode 135 shown in FIG. 1. Cover plate 340 isolates fluid flowing in channel region 350 from contacting electrode 335. Dry electrodes can be positioned in alternate locations that are generally in close proximity to the mixing channel, provided electrode 335 does not contact the fluid. Use of a dry electrode has been shown to reduce the power supply current needed for a fixed potential difference.

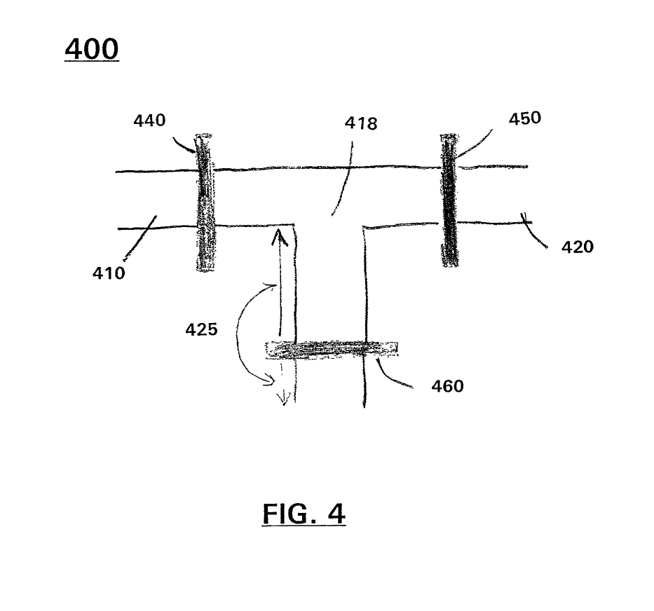

Microchannel mixing device 400 shown in FIG. 4 is another alternative design for EHD mixing. The first and second supply channels 410 and 420 intersect at intersection 418. Electrohydrodynamic mixing can be provided by placing at least one electrode 440 in supply channel 410 and at least one electrode 450 in supply channel 420. A third electrode 460 is disposed in or adjacent to mixing channel 425 at some distance downstream from intersection 418. An electric field is generated in mixing channel 425 above the electrode by imposing a potential difference between electrodes 440 or 450 with electrode 460 to induce EHD mixing. Accordingly, microchannel mixing devices 100 and 400 can be configured to provide both electrohydrodynamic mixing and electroosmotic transport depending upon the buffer composition.

Electrohydrodynamic mixing generally requires that a threshold electric field strength be provided. Larger potential differences are required to provide stronger electric fields. The required electric field strength is generally a function of device geometry and the particular fluids used. By providing closely spaced electrodes, such as 25 μm apart, only moderate potentials, such as 50 V, can be used to induce EHD mixing for certain fluids. For example, electric field strengths up to 20 kV/cm can be generated between electrodes 105 and 135 shown in FIG. 1 by applying a 50 V potential difference across a 25 μm electrode spacing.

Low voltage requirements for EHD mixing provided by the invention are desirable for a number of reasons. First, lower voltage requirements consume less power and provide increased flexibility in choosing power supplies. In addition, reduced voltage requirements permit increased temporal control of electrical signals, which can be desirable for certain applications.

To visualize the mixing of two fluids, microchannel mixing device 100 shown in FIG. 1 was used. One of the fluids was doped with fluorophore rhodamine B. A pressure of 0.1 bar below ambient pressure was applied at an output reservoir disposed at the distal end of mixing channel 125 while holding reservoirs connected to respective supply channels 110 and 120 at ambient pressure to draw the first and second fluids into mixing channel 125. Flow velocities in supply channels 110 and 120 were estimated to be approximately 7 mm/s from particle velocity measurements performed.

The voltage applied between electrodes 105 and 135 generates an electric field which results in EHD fluid mixing. The actual fluid mixing depends on the geometry of the electrodes, the properties of the fluids and the applied voltages.

Electrodes can be biased using a DC voltage, a pulsed DC voltage (e.g. a square wave signal) or an AC voltage signal, such as a sinusoidal or triangular voltage signal. More than one power supply can be used with the invention, even when only two electrodes are used. For example, one power supply can be biased positively and a second can be biased negatively.

Use of an AC bias can provide high peak voltages and lower average voltages. An AC bias can also eliminate or at least substantially reduce the occurrence of certain undesirable electrochemical reactions that can occur at electrodes in contact with the fluid. For example, use of an AC bias can limit or eliminate the electrolysis of water.

A hybrid design can be used to form the microchip mixing device. A hybrid design includes a cover plate and substrate, the respective layers being formed from different materials. Preferred substrates provide good mechanical properties and are chemically unreactive to fluids used. For example, a glass or silica substrate can be used with most common fluids.

In certain applications, it is preferable to have a gas permeable cover plate to permit the escape of gases that may be evolved during the application of electric potential. For example, H₂ and O₂ are electrolysis products of water which are produced when the potential applied between the electrodes exceeds a certain threshold. A polydimethylsiloxane polymer (PDMS) (Sylgard 184; Dow Corning, Midland, Mich.) cover plate can allow these gases to diffuse away from the fluidic channels.

A molding process can be used to form flow channels in the cover plate. Polymers are known to be well adapted to molding processes. Once formed, the cover plate can be secured to the substrate using known methods, such methods disclosed by Duffy et al, Anal. Chem. 1998, 70, 4974.

A cover plate having a fluid channel design such as that shown in FIG. 1 can be formed by casting PDMS. PMDS is substantially gas permeable and facilitates the removal of gas-phase species which can be electrochemically generated at the electrodes in the microchip channels. The glass substrate can provide rigid support on which to pattern the electrode design and to couple a pressure source and electrical contacts to the microchip.

Molds which can be used to cast a patterned cover plate can be formed by a number of techniques. For example, conventional photolithography and etching commonly used in the microelectronics industry can be employed to etch materials such as silicon and glass (SiO₂). The lithography tool, photoresist used and etching method used can be tailored by the device dimension requirements and tolerances. For most applications, projection alignment can be used together with an optically sensitive photoresist. Various etching techniques can be used including wet etching, plasma etching and reactive ion etching. Reactive ion etching is generally preferred due to its ability to form substantially vertical walls.

After the mold is formed, the cover plate may be cast in the mold. For example, PDMS can be mixed and cured at 90° C. for 2 hours in the mold. The channel dimensions formed in the cover plate produced can be user defined, and be as small as several microns in depth and width. In the example described herein, the channel dimensions were 15 to 30 μm deep and 50 to 110 μm wide.

Sample dimensions for the various channels of microchannel mixing device 100 in FIG. 1 can be channel 110 length 5.7 mm, channel 120 length 5.5 mm and mixing channel 125 length 12.7 mm. Each channel can be 37 μm deep and 106.5 μm wide at the top and 50 μm wide at the bottom. The distance between the active electrodes 105 and 135 can be 450 μm. As noted above, channel dimensions, including their cross sections, can be customized.

Electrodes can be formed on the substrate using a variety of techniques to deposit electrically conductive layers, such as metals. For example, chemical vapor deposition and sputtering can be used to deposit metal which can be used to form electrodes. Typical electrode layer thickness can be from 50 to 1000 nm, preferably being about 100 nm (0.1 μm). Electrode contact pads are preferably provided which extend beyond the area coverage of the cover plate to facilitate electrical contact to the same.

Assuming a blanket deposition process is used to deposit the conductive layer across the substrate surface, the conductive layer can then be defined using methods such as photolithography and etching described above. In one embodiment, the electrodes formed can be 20 μm wide and 0.1 μm high.

Access ports can then be formed in the cover plate, such as PMDS, by any suitable method. For example, a hole punch has been used to form the access holes in a PDMS cover plate.

The substrate and cover plate can then be joined to form a closed network of flow channels. The cover plate and substrates can be reversibly sealed by cleaning both surfaces and contact bonding the cover plate to the substrate. Alternatively, the cover plate and substrate can be irreversibly sealed by exposing both surfaces to an oxygen plasma and then bringing the respective layers into contact.

### EXAMPLES

Fluids from channels 110 and 120 (FIG. 1) were drawn into the T-intersection by applying a sub-ambient pressure of approximately 10 psia to a reservoir disposed at the outlet of mixing channel 125. To effect EHD mixing, the output of a programmable high voltage power supply was applied to the electrode contact pads extending beyond the area covered by the PDMS substrate. Input to the power supply was computer controlled. Typically, electrode 135 was grounded, and a negative potential was applied to electrode 105. However, the mixing behavior did not depend on the orientation of the voltage applied between the electrodes, only the magnitude of the potential difference applied.

Fluid transport and mixing of fluids were monitored by doping one of the fluid streams with rhodamine B and using fluorescence detection. Two dimensional (2D) images were acquired using an inverted optical microscope and a CCD camera. The spatial uniformity of the excitation source was calibrated by flowing an equal concentration of dye through the channels of the microchannel mixer 100. Ethanol/ethanol, ethanol/butanol, and butanol/butanol mixtures were tested. Flow velocities were determined by measuring the distance traveled in 50 ms for 1.0 μm particles using time-lapsed fluorescence CCD imaging.

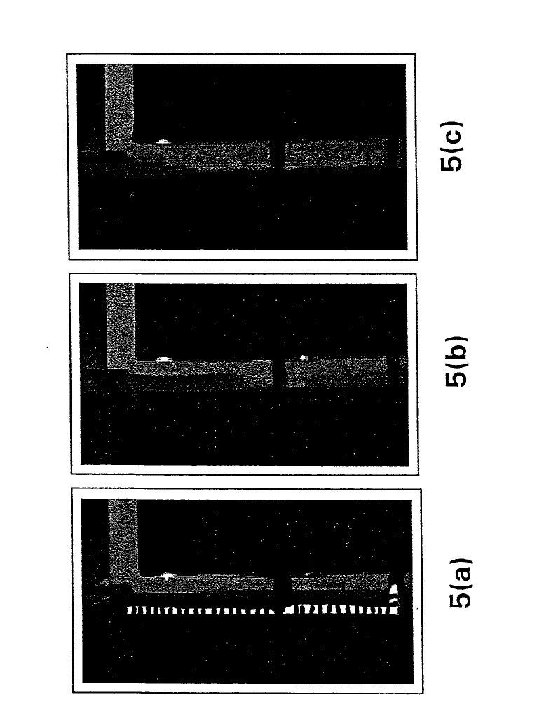

FIGS. 5(a), (b) and (c) show three fluorescence images of ethanol from a reservoir at the inlet to supply channel 110 and ethanol with rhodamine B from a reservoir at the inlet to supply channel 120 being mixed with 0, 75, and 200 V applied between electrodes 105 and 135 in FIGS. 5(a), (b) and (c), respectively.

FIG. 5(a) represents diffusive transport. Very little mixing is observed, and the mixing is by diffusion only with 0 V applied. The fluorescence (bright area) is on the right hand side of the mixing channel 125. In FIG. 5(b), moderate mixing was observed when 75 V was applied. In FIG. 5(c), more thorough mixing was demonstrated when 200 V was applied. With 200 V applied, the fluorescence was nearly uniform across the mixing microchannel 125 showing that the first and second fluids were thoroughly mixed. For ethanol/butanol and butanol/butanol mixtures, similar mixing results were observed. FIG. 5 shows a simple dilutution experiment. Similarly, reagents can be combined, mixed and reacted to form at least one product.

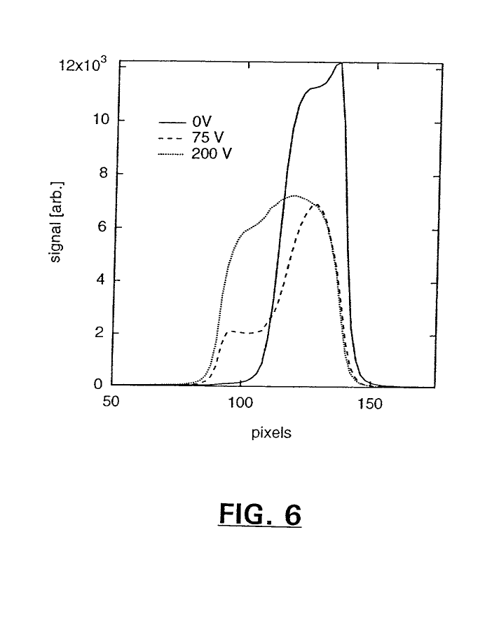

FIG. 6 illustrates a plot of the fluorescence intensity of cross sections of the respective images in FIGS. 5(a), (b) and (c) taken perpendicular to the fluid flow at a point 80 μm downstream from the intersection 118. With 200 V applied, the signal is roughly constant over the entire cross section shown.

While the preferred embodiments of the invention have been illustrated and described, it will be clear that the invention is not so limited. For example, the invention may be used for combinational chemistry and liquid-liquid extraction of liquids including organic solvents. The invention is useful for microreactors for chemical synthesis and can be used to process chemical reactions including those with fast kinetics, low production rates or hazardous reagents or products. Numerous other modifications, changes, variations, substitutions and equivalents will occur to those skilled in the art without departing from the spirit and scope of the present invention as described in the claims.

We claim:

1. A microchannel mixing device for electrohydrodynamic mixing of fluids, comprising:
a mixing channel, said mixing channel having an inlet for receiving at least one fluid;
at least one supply channel fluidicly connected to said mixing channel inlet for transport of said fluid into said mixing channel inlet, and
at least two electrodes for imposing an electric field in said mixing channel, at least one of said electrodes adapted for charging at least a portion of said fluid.

2. The mixing device of claim 1, wherein said at least one supply channel comprises a first supply channel for a first fluid and a second supply channel for a second fluid.

3. The mixing device of claim 2, wherein at least one of said electrodes is disposed within said first or second supply channels.

4. The mixing device of claim 1, wherein at least one of said electrodes is a fluid isolated electrode disposed in a location which is not in contact with said fluid.

5. The mixing device of claim 1, wherein said mixing device further comprises a cover plate in contact with a substrate.

6. The mixing device of claim 5, wherein said mixing channel and supply channel are formed in said cover plate.

7. The mixing device of claim 5, wherein said cover plate is gas permeable.

8. The mixing device of claim 5, wherein said substrate comprises silica or glass.

9. The mixing device of claim 1, further comprising at least one power supply for applying a DC, pulsed DC or AC voltage to any of said electrodes.

10. The mixing device of claim 9, wherein said power supply comprises at least two independent power supply channels.

11. The mixing device of claim 2, wherein said first and second fluids are mixed in said mixing channel, wherein at least one product is formed from a reaction.

12. The mixing device of claim 1, wherein said electrodes are positioned along a length of said mixing channel, wherein a potential difference applied between said electrodes produces an electric field oriented substantially parallel or anti-parallel to a direction of flow of said fluid in said mixing channel.

13. The mixing device of claim 1, wherein said electrodes are positioned transverse to a length of said mixing channel, wherein a potential difference applied between said electrodes produces an electric field oriented substantially transverse to a direction of flow of said fluid in said mixing channel.

14. A method for electrohydrodynamically mixing fluids, comprising the steps of:
delivering at least one fluid into a mixing channel;
inducing a charge on at least a portion of said fluid; and
applying an electric field across at least a portion of said mixing channel, wherein at least one of said fluid is mixed.

15. The method of claim 14, wherein said electric field originates or terminates outside said mixing channel.

16. The method of claim 14, further comprising the step of releasing gas evolved from said applying step.

17. The method of claim 16, wherein said releasing step comprises diffusion across a gas permeable layer.

18. The method of claim 14, wherein said applying step comprises application of a DC voltage.

19. The method of claim 14, wherein said applying step comprises application of a time varying voltage signal.

20. The method of claim 19, wherein said time varying voltage signal comprises a pulsed DC signal.

21. The method of claim 14, wherein said applying step comprises applying voltage using at least two independent power supply channels.

22. The method of claim 14, wherein said electric field applied is substantially parallel or anti-parallel to a direction of flow of said fluid in said mixing channel.

23. The method of claim 14, wherein said electric field applied is oriented substantially transverse to a direction of flow of said fluid in said mixing channel.
